(19) United States
(12) Patent Application Publication
(10) Pub. No.: US 2026/0160628 A1
(43) Pub. Date: Jun. 11, 2026

(54) DEVICE FOR MEASURING PRESSURE, FORCE OR TEMPERATURE

(71) Applicant: SYSTEC AUTOMOTIVE GMBH, Puchheim (DE)

(72) Inventors: Mohan ALEATBI, München (DE); Oliver BETZ, Gröbenzell (DE)

(21) Appl. No.: 18/723,553

(22) PCT Filed: Nov. 29, 2022
(86) PCT No.: PCT/EP2022/083628

§ 371 Date: Jun. 24, 2024

(30) Foreign Application Priority Data
Dec. 22, 2021 (DE) 10 2021 134 430.1

(51) Int. Cl. G01L 19/06; G01L 9/12; G01L 19/00

(52) U.S. Cl. CPC G01L 19/0645; G01L 9/12; G01L 19/0092

(57) ABSTRACT

A device measures pressure, force or temperature. The device contains a substrate for a sensor and a housing that seals the sensor off from an ambient pressure. The housing has a connection element via which a carrier medium of the pressure to be measured or of the force to be measured is in communication with the interior of the housing. The sensor is covered by a corrosion-resistant gel which prevents direct contact between the sensor and the carrier medium transmitting the pressure or the force. A partition surrounds the sensor and is spaced apart from the housing and is located between the housing and the sensor.

The invention relates to a device for measuring pressure, force or temperature, having a substrate for a sensor and a housing that seals the sensor off from an ambient pressure, wherein the housing has a connection element, via which a carrier medium of the pressure to be measured or the force to be measured is in communication with the inside of the housing and wherein the sensor is covered by a corrosion-resistant gel, which prevents direct contact between the sensor and the carrier medium transmitting the pressure or the force.

Silicon-based sensors are used as pressure, force and temperature sensors. They can only be used unprotected in non-corrosive, dry environments. This also applies to the electrical connections of the sensors with their substrate, the so-called bondings, and the substrate or the circuit board of the sensor itself. The metallic surfaces of the sensors and substrates experience severe corrosion and leakage currents due to the electrical potentials of the measurement once conductive, for example ionogenic condensates are present in the measurement atmosphere. Such leakage currents make measurement impossible, and the corrosion destroys the measuring arrangement over time.

In the prior art, inside the sensor chamber surrounded by the housing, the silicon sensors are protected from corrosion and leakage currents by moulding them with gel-like coatings. These corrosion-resistant gels, usually but not exclusively fluorinated silicones, reliably transmit force, pressure or temperature and are largely chemically inert to many agents.

In order for the gels to be able to transmit the pressure, force of temperature to be measured as accurately as possible, their rheological properties are adjusted such that they no longer flow or drip after dosing and a holding time and at the same time only exert little or no force on the silicone sensor to be protected as a result of thermal expansion. The gels are also largely incompressible.

This configuration proves problematic if there is a significant difference between the ambient pressure pu and the measuring pressure p1. Large pressure differences between the ambient pressure pu and the measuring pressure p1 inside the housing can lead to the housing being deformed.

Deformation of the housing leads to force being transmitted to the gel on the housing wall, which transmits this force to the sensor. These forces are superimposed on the pressure p1 to be measured and lead to measurement errors.

In particular, when measuring differential pressures, these errors prove problematic. Here, the ambient pressures pu are often many times higher than the differential pressures to be measured. Ambient pressures of, for example, 20 bar are contrasted with differential pressures to be measured of, for example, 0,0002 bar, i.e. in a ratio of 10.000:1.

Deformation of the housing by a mechanical force F exerted on the housing is also problematic. Mechanical forces occur in particular when the circuit board is moulded outside the sensor chamber, and this often hard moulding, for example made of polyurethane, acts on the housing due to thermal expansion. Such forces also lead to the housing being deformed.

Another source of a mechanical force F acting on the housing involves mechanical load on the connection piece for the conduit, by means of which the pressure to be measured is applied to the inside of the housing. Examples of such mechanical loads are stresses between the conduit and the connection piece, stresses caused by O-rings for sealing the connection piece or stresses caused by the connection piece being glued to the housing.

The object of this invention is to propose a device for measuring pressure, force or temperature that prevents the measurement errors caused by deformation of the housing.

This object is achieved by a measuring device with the features according to claim 1. Some preferred embodiments of the inventions are presented in the claims dependent on claim 1.

The basic idea of the invention is to propose a device in which a partition that surrounds the sensor and is spaced apart from the housing is arranged between the housing and the sensor. The partition connected to the substrate thus forms a container within the housing, which contains the sensor and the gel covering it.

Arranged in such a way, the partition separates the corrosion-resistant gel from the housing. The gel applied to the sensor is no longer on the inner wall of the housing, but rather on the side of the partition facing the sensor. Thanks to the distance between the partition and housing, any deformation of the housing can no longer have a direct effect on the gel. As a result of the lack of direct contact between the housing and the gel arranged inside the partition, any deformation of the housing does not result in a direct transmission of force to the gel and therefore no transmission of force by the gel to the sensor. The measurement error that would otherwise result from this is avoided by the design of the partition according to the invention.

It is advantageous if the space between the partition and the housing is filled with the carrier medium of the pressure to be measured or the force to be measured, i.e. there is no direct contact between the partition and the housing.

One particular advantage of the solution according to the invention is that measurement errors induced by the assembly of the measuring device can also be avoided. After the sensor has been moulded with the gel, when the housing is closed with the connection piece and the measuring pressure transmitting conduit is attached to the housing, mechanical forces act on the housing. These are no longer directly transmitted to the gel.

Another advantage results from the type of attachment of the partition to the substrate that is now possible. The housing is glued to the substrate in the prior art. It is usually glued using solvent-based adhesives, so-called volatile organic components (VOC). Such a connection between the substrate and the housing is sufficiently strong to withstand loads from forces acting on the housing from the outside. However, the outgassing solvents of the solvent-based adhesives contaminate the gel. The contamination leads to bubbles in the gel or chemical reactions with the gel. These problems lead to measurement errors. In contrast, the partition according to the invention can be connected to the substrate by means of friction welding, in particular ultrasonic welding. The friction welding connection has a lower strength than gluing with solvent-based adhesives. However, this is no problem for the partition spaced apart from the housing as hardly any mechanical forces act between the partition and the substrate.

The measuring device according to the invention preferably utilises the principle of the Wheatstone bridge based on silicon-based MEMS (micro-electromechanical systems) or capacitive pressure sensors for the measurement.

The invention is explained further based on the following four figures.

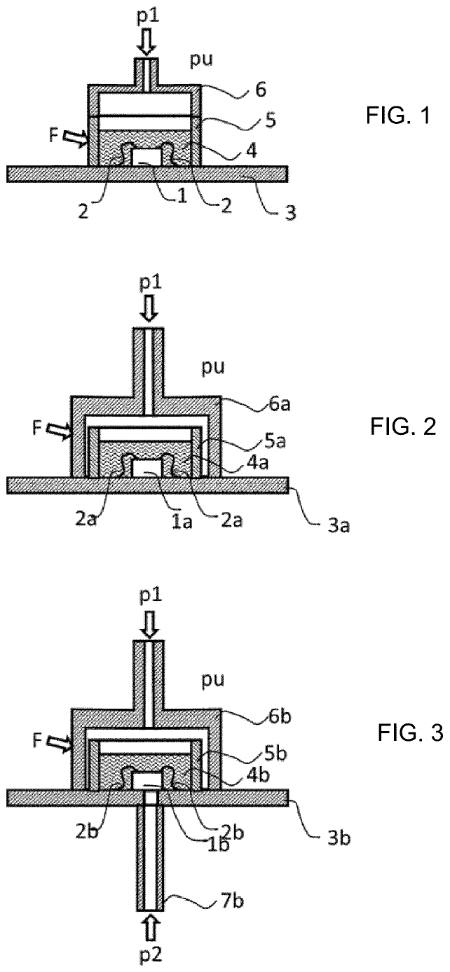

FIG. 1 shows a sectional view of a device for measuring absolute pressure according to the prior art;

FIG. 2 shows a device for measuring pressure according to the invention;

FIG. 3 shows a device for measuring differential pressure according to the invention; and

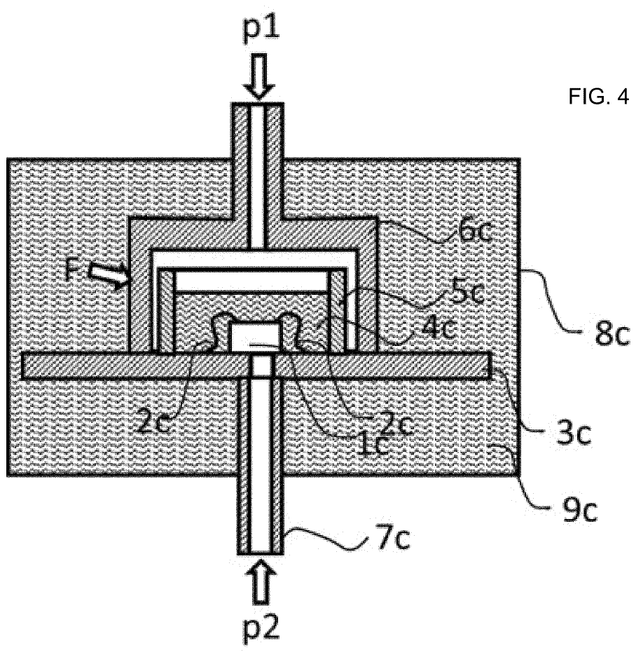

FIG. 4 shows a measuring device according to FIG. 1 with moulding and an outer housing.

FIG. 1 shows a silicon-based sensor 1, which is attached to a substrate 3. The sensor 1 is connected to conductor tracks (not shown here) running through the substrate 3 via microwires or bondings 2. The sensor 1 is connected to an electrical evaluation unit (not shown here either) via the bondings 2 and conductor tracks.

The sensor 1 is surrounded by a housing 5, which is closed and shielded from the ambient pressure pu by a connection element, via which a carrier medium of the pressure to be measured is in communication with the inside of the housing, the connection piece 6. The pressure p1 to be measured is applied to the inside of the housing 5 via the connection piece 6. The sensor 1 and the bondings 2 are covered by a corrosion-resistant gel 4, which has been inserted inside the housing.

FIG. 2 shows a sectional view of a measuring device according to the invention for measuring an absolute pressure. It has a sensor 1a in the form of a silicon-based MEMS, which is attached, preferably glued or soldered, to a substrate 3a. The sensor 1a is connected to conductor tracks running through the substrate 3a via a plurality of microwires or bondings 2a. The sensor 1a is connected to an electrical evaluation unit (not shown here) via the bondings 2a and conductor tracks. The substrate 3a can therefore be a circuit board, but can also be made of ceramic or plastic with conductor tracks applied.

The bondings 2a can be attached to the sensor 1a and the substrate 3a by ultrasonic friction welding. Soldering or welding the bondings 2a is a suitable alternative connection.

With the measuring device according to the invention, the sensor 1a is also surrounded by a housing 6a, which is closed and shielded from the ambient pressure pu by a connection piece, via which a carrier medium of the pressure to be measured is in communication with the inside of the housing. The connection piece can be connected, for example glued, to the housing 6a, but can also be integrally formed with it. The pressure p1 to be measured is fed into the inside of the housing 6a via the connection piece, for example by virtue of the fact that a conduit transmitting the pressure p1 is connected to the connection piece.

A partition 5a spaced apart from the sensor 1a and the housing 6a is arranged between the housing 6a and the sensor 1a. The partition 5a protruding from the substrate 3a is attached, in particular glued or connected by means of friction welding, preferably ultrasonic welding, to the substrate 3a, and completely surrounds the sensor 1a. In this way, together with the substrate 3a, it forms an open container or open cavity, which completely accommodates the sensor 1a and the bondings 2a. The gel 4a for covering the sensor 1a and the bondings 2a is inserted into this container until it covers the sensor 1a and the bondings 2a.

It is therefore possible to cover the sensor 1a attached to the substrate 3a and contacted by means of the bondings 2a with the gel 4a and only then close the space surrounding the partition 5a with the housing 6a.

After the holding time has elapsed, the gel 4a remains in the container formed by the substrate 3a and the partition 5a due to its rheological properties. Direct contact between the partition 3a and the housing 6a is ruled out as a result of the spacing. Deformation of the housing 6a caused by a mechanical force F acting on the housing 6a, for example by moulding of the housing 6a and substrate 3a, does not result in deformation of the partition 5a and therefore does not lead to force being transmitted to the gel 4a covering the sensor 1a as would otherwise be expected. Even in the event of large differences between the ambient pressure pu and the pressure p1 to be measured, the partition 5a does not undergo deformation because it has no contact to the ambient pressure pu. The partition 5a is surrounded by an area, in which there is only the pressure p1 to be measured.

FIG. 3 shows a sectional view of a measuring device according to the invention for measuring a differential pressure. The features shown here, i.e. sensor 1b, bondings 2b, substrate 3b, gel 4b, partition 5b, housing 6b, force F and the connection piece for the pressure p1 correspond to the features set out for the device for measuring absolute pressure in terms of their properties.

A second connection piece 7b is arranged on the side of the substrate 3b facing away from the sensor 1c, via which the pressure p2 required for the differential pressure measurement is fed into the measuring device. The substrate 3b has an opening, through which the pressure p2 can be applied to the sensor 1c.

The measuring device for measuring a differential pressure according to FIG. 3 is surrounded by an outer housing in FIG. 4, from which the ends of the two connection pieces for applying the pressures p1 and p2 protrude. All features denoted by reference numerals are marked with the suffix c instead of the suffix b in contrast to FIG. 3. For example, the sensor 1b shown in FIG. 3 is shown as sensor 1c in FIG. 4. In order to protect the components and conductor tracks arranged inside the outer housing 8c, particularly the electronic components, the free space 9c located between the measuring device and the outer housing 8c is moulded, typically with a polyurethane.

1-7. (canceled)

8. A device for measuring pressure, force or temperature, the device comprising:
a sensor;
a substrate for said sensor;
a housing sealing said sensor off from an ambient pressure, wherein said housing has a connection element, via which a carrier medium of the pressure to be measured or the force to be measured is in communication with an inside of said housing;
a corrosion-resistant gel covering said sensor for preventing direct contact between said sensor and the carrier medium transmitting the pressure or the force; and
a partition surrounding said sensor and being spaced apart from said housing is disposed between said housing and said sensor.

9. The device according to claim 8, wherein a space between said housing and said partition is filled with the carrier medium of the pressure to be measured or the force to be measured.

10. The device according to claim 8, further comprising:
an outer housing; and
a potting compound, wherein a free space between said housing and said outer housing is filled with said potting compound.

11. The device according to claim 8, further comprising:
bondings; and
conductor tracks running through said substrate and are connected to said sensor by means of said bondings.

12. The device according to claim 8, wherein said corrosion-resistant gel is a silicone-based and fluorine doped gel.

13. The device according to claim 8, wherein said sensor is a silicone-based micro-electromechanical systems (MEMS) or a capacitive pressure sensor.

14. The device according to claim 8, further comprising a connection between said substrate and said partition being a friction welding connection.

15. The device according to claim 14, wherein said friction welding connection being a connection formed by means of ultrasonic welding.
